(19) United States
(12) Patent Application Publication
(10) Pub. No.: US 2005/0098549 A1
(43) Pub. Date: May 12, 2005

(54) Laser beam machining apparatus

(75) Inventors: Yasushi Ito, Ebina (JP); Futao Naruse, Ebina (JP); Fumihiro Ueno, Ebina (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Via Mechanics, Ltd., Ebina-shi (JP)

(21) Appl. No.: 11/014,778

(22) Filed: Dec. 20, 2004

(30) Foreign Application Priority Data
Oct. 21, 2003 (JP) 2003-361017

(51) Int. Cl. B23K 26/08

(52) U.S. Cl. 219/121.78; 219/121.82

(57) ABSTRACT

The present invention relates to a laser beam machining apparatus which enables plural sheets of work to be mounted so as to be simultaneously processed, and which has a small size, even in the case where the number of sheets of work is increased. The laser beam machining apparatus includes a XY table which enables a work to be mounted on a bed of the laser beam machining unit and which is movable in the X and Y axis directions, and a gate-shaped over-frame having a laser irradiation optical system which irradiates a laser beam on the above described work so as to perform drilling or cutting, wherein the above described laser irradiation optical system is supported so as to be movable in the Z axis direction, wherein the bed of the laser beam machining unit is cut out in left and right front portions so as to make installation parts for leg parts of the gate-shaped over-frame left behind, and wherein a work feed unit and a work discharge unit are arranged so as to be inserted into the above described left and right front cutout portions.

### BACKGROUND OF THE INVENTION

The present invention relates to a laser beam machining apparatus and more particularly to a laser beam machining apparatus which processes blind holes with a laser for connecting a copper foil layer on the surface of a multilayer printed board with an inner copper foil layer of the same.

### PRIOR ART

FIG. 6 shows an example of the laser beam machining apparatus which processes blind holes with a laser for connecting a copper foil layer on the surface of a multilayer printed board with an inner copper foil layer of the same, and also shows a plan view and an outline dimension of the laser beam machining apparatus which is manufactured and sold by the present applicant. In FIG. 6, A is a laser beam machining unit, B is a work feed unit and C is a work discharge unit, in which figure the laser beam machining unit A, the work feeding unit B and the work discharge unit C, which each has a rectangular shape, are adjacently arranged.

FIG. 7 shows an example of the internal structure of a conventional laser beam machining apparatus which processes a blind holes with a laser for connecting a copper foil layer on the surface of a multilayer printed board with an inner copper foil layer of the same, wherein a XY table consisting of a Y table 2 which is movable in the arrow Y direction and a X table 3 which is mounted on the Y table 2 and movable in the arrow X direction is supported on the bed 1 so as to support a work 4. In addition, a laser oscillator 6 is mounted on a column 5 which is vertically provided on the bed 1 so as to straddle the moving region of the XY table, and a machining head 7 is also supported by the column 5 so as to be movable in the arrow Z direction.

The above described machining head 7 consists of an upper cylindrical body movable in the arrow Z direction and a lower cylindrical body supported by the upper cylindrical body, and a condenser lens for condensing a laser beam on the work 4 is supported by the upper cylindrical body, and a window lens for protecting the condenser lens is supported by the lower cylindrical body, respectively. The work 4 with laser irradiation window holes formed beforehand is fixed on the X table 3 and is positioned at a predetermined position through operation of servo motors. Pulse-like laser beams are then emitted from the laser oscillator 6 so as to be condensed by the condenser lens on the window hole of the work 4, thereby enabling processing of the blind holes to be performed. Another similar technique is also disclosed in JP-A-2003-136274.

In such a laser beam machining apparatus, those provided with a XY table allowing two sheets of work to be mounted thereon is shown as an exemplary embodiment in FIG. 6 of JP-A-07-32183.

Besides the laser beam machining apparatus, a machining apparatus which enables machining the blind holes with drills and which is allowing a number of works to be mounted, is disclosed in JP-A-62-297042.

### SUMMARY OF THE INVENTION

In such a laser beam machining apparatus, as described above, the configuration of the machining unit body is normally formed in a rectangular shape within a plane of the XY table, irrespective of one or two sheets of work mounted on the machining unit. On the other hand, in the laser beam machining apparatus of this type, it is considered first to enlarge a work substrate in order to improve the productivity, but simply enlarging the size of the work substrate will only cause the whole device to be large-sized and is not a preferred method. Hence, it is considered that a plurality of optical systems are provided so as to enable plural sheets of work to be mounted and simultaneously processed. However, any modification described above will make the machining unit large-sized.

Accordingly, it is an object of the present invention to provide a laser beam machining apparatus for enabling plural sheets of work to be mounted and simultaneously to be processed, and also to provide a small-sized laser beam machining apparatus without simply enlarging the machining apparatus corresponding to the increase in the number of sheets of work.

According to the invention, there is provided a laser beam machining apparatus comprising: a XY table which enables a work to be mounted on a bed of the laser beam machining unit and which is movable in the X and Y axis directions; and a gate-shaped over-frame having a laser irradiation optical system which irradiates laser lights on the above described work so as to perform drilling or cutting, wherein the above described laser irradiation optical system is supported so as to be movable in the Z axis direction, wherein the bed of the laser beam machining unit is cut out in the left and right front portions, so as to make installation parts for leg parts of the gate-shaped over-frame left behind, and wherein a work feed unit and a work discharge unit are arranged so as to be inserted into the above described left and right front cutout portions.

Further, according to the invention, there is provided a laser beam machining unit wherein the work mounted on the XY table is two sheets of work and the laser irradiation optical system is arranged pairwise so as to correspond to the above described two sheets of work.

The bed of the laser beam machining unit, according to the invention, is cut out in the left and right front portions so as to make installation parts for leg parts of the gate-shaped over-frame left behind, and the work feed and discharge units are arranged so as to be inserted into the above described left and right front cutout portions, as a result of which the width of the laser beam machining apparatus can be reduced, thereby enabling the whole apparatus to be miniaturized.

Further, in the laser beam machining apparatus, according to the invention, in which the work mounted on the XY table is two sheets of work and the laser irradiation optical system is arranged pairwise so as to correspond to the above described two sheets of work, the bed of the laser beam machining unit is cut out in the left and right front portions so as to make installation parts for leg parts of the gate-shaped over-frame left behind, and the work feed and discharge units are arranged so as to be inserted into the above described left and right front cutout portions, as a result of which the width of the laser beam machining apparatus can be reduced so as to enable miniaturization of the whole apparatus to be attained, while enhancing the production efficiency.

Other objects, features and advantages of the invention will become apparent from the following description of the embodiment of the invention taken in connection with the accompanying drawings.

### BRIEF DESCRIPTION OF THE DRAWINGS

FIG. 1 is a schematic top view showing a state in which a feed unit B and a discharge unit C are arranged so as to be inserted into a laser beam machining unit A;

FIG. 2 is a top view showing a state in which the feed unit B and the discharge unit C are arranged so as to be inserted into the laser beam machining unit A;

FIG. 3 is a front view showing a state in which the feed unit B and the discharge unit C are arranged so as to be inserted into the laser beam machining unit A;

FIG. 4 is a side view showing a state in which the feed unit B and the discharge unit C are arranged so as to be inserted into the laser beam machining unit A;

FIG. 5 is a schematic perspective view showing arrangement relation of each component constituting the laser beam machining unit A;

FIG. 6 is a schematic top view showing a state in which the feed unit B and the discharge unit C are arranged for a conventional laser beam machining unit A; and

FIG. 7 is a schematic perspective view showing arrangement relation of each component constituting the conventional laser beam machining unit A.

### PREFERRED EMBODIMENTS OF THE INVENTION

In the following, an exemplary embodiment as the best mode for carrying out the present invention will be described, with reference to the accompanying drawings. Of course, it will be obvious that the invention is readily applied to numerous arrangements other than those explained by way of the exemplary embodiment, without deviating from the spirit and scope of the invention.

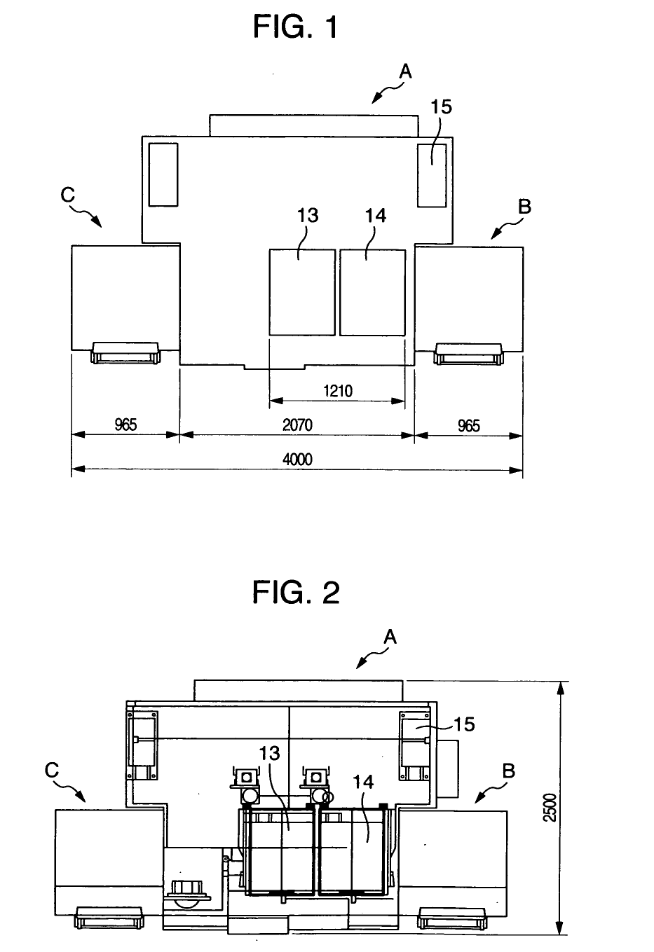

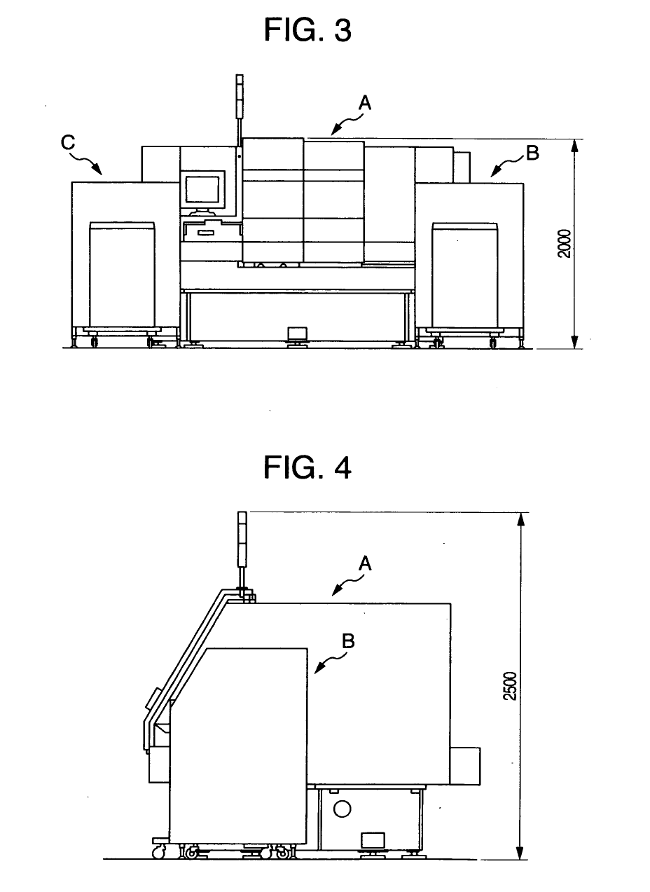

FIGS. 1 to 4 are figures showing a state in which a feed unit B and a discharge unit C are arranged so as to be inserted into a laser beam machining unit A, and are external views of the apparatus developed practically by the present inventors.

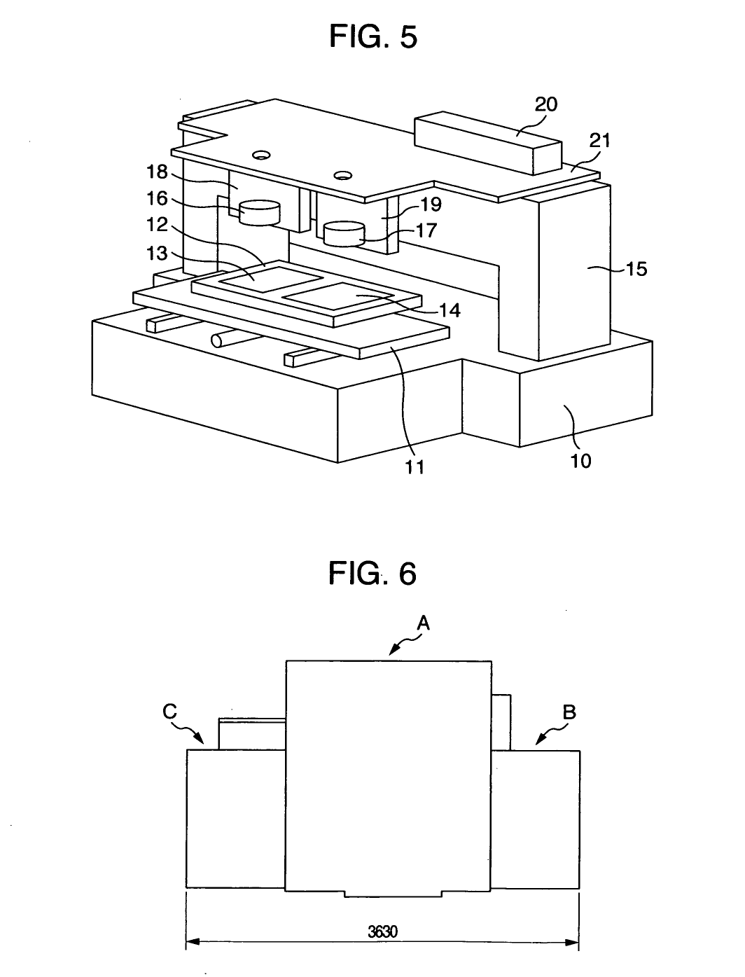

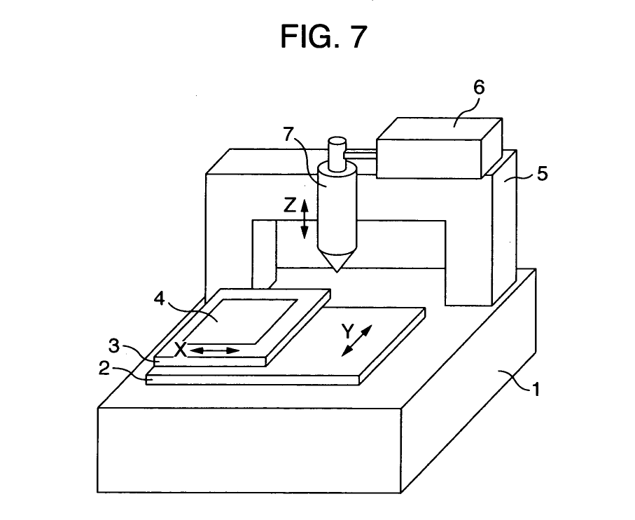

FIG. 5 is a schematic perspective view showing arrangement relation of each component constituting the laser beam machining unit, in which a linear guide for guiding a cross-table 11 freely movably in the Y axis direction is arranged on the top surface of a bed 10 of the laser beam machining unit A. On the top surface of the cross-table 11, there is arranged a linear guide for guiding a table 12 freely movably in the X axis direction. The table 12 and the cross-table 11 are driven by servo motors (not shown), respectively. Two sheets of work 13, 14 are fixed on the top surface of the table 12 by means of clamping devices.

A gate-shaped over-frame 15 is vertically installed on the bed 10. On the upper side surface of the over-frame 15, a pair of laser heads (only Fθ lenses 16, 17 are shown in the figure) are vertically movably supported by Z tables 18, 19 so as to face against the two works 13, 14. Between a laser oscillator 20 and the laser heads (Fθ lenses 16 and 17), there is arranged an optical system for converging and irradiating a laser beam emitted from the laser oscillator 20 on the works. The optical system devices are arranged on an optical path plate 21.

The transporting section of the feed unit B and the discharge unit C comprises a workpiece sucking device (not shown) for transporting the work to the laser beam machining unit A, similarly to the conventional apparatus.

In the size of the laser beam machining unit A which is an exemplary embodiment of the present invention, as is apparent from FIG. 1, despite the fact that the laser beam machining unit enables two sheets of work, each having a width of about 600 mm, to be lined up and processed, the overall apparatus size of 4000 mm, including the size of the feed unit B and the discharge unit C, has been achieved.

As is apparent from FIG. 1 and FIG. 2, this is because the bed 10 of the laser beam machining unit A is cut out in the left and right front portions so as to make installation parts for leg parts of the gate-shaped over-frame 15 left behind, and the work feed unit B and the work discharge unit C are arranged so as to be inserted into the above described left and right front cutout portions. The gate-shaped over-frame 15 supports the laser optical system necessary for laser beam machining, and because the laser optical system is required to be structurally firmly constructed in order to secure a high precision machining, so that leg parts of the over-frame can not be made thin. Therefore, the left and right front portions are cut out so as to make installation parts for leg parts of the gate-shaped over-frame 15 left behind, thereby enabling miniaturization of the whole apparatus to be attained.

When it is assumed that the size of the work substrate is the same and the productivity in the case of processing one work substrate by one galvano meter optical system is 100, the productivity in the case of processing one work substrate by two galvano meter scan optical systems becomes 140 to 160, and the productivity in the case of processing each of two work substrates by one galvano meter optical system becomes 200.

On the other hand, by applying the invention, the area occupied by a device of galvano meter scan system, even by a device for processing two work substrates, increases only by 2 to 5% relative to the conventional apparatus for processing one work substrate, thereby enabling a laser beam machining apparatus having a small size and high productivity to be realized.

It should be further understood by those skilled in the art that although the foregoing description has been made on embodiments of the invention, the invention is not limited thereto and various changes and modifications may be made without departing from the spirit of the invention and the scope of the appended claims.

1. A laser beam machining apparatus comprising:
a XY table which enables a work to be mounted on a bed of the laser beam machining unit and which is movable in the X and Y axis directions; and a gate-shaped over-frame having a laser irradiation optical system which irradiates laser beams on said work so as to perform drilling or cutting, wherein said laser irradiation optical system is supported so as to be movable in the Z axis direction, wherein the bed of said laser beam machining unit is cut out in left and right front portions so as to make installation parts for leg parts of said gate-shaped over-frame left behind, and wherein a work feed unit and a work discharge unite are arranged so as to be inserted into said left and right front cutout portions.

2. The laser beam machining device according to claim 1, wherein the work mounted on said XY table is two sheets of work and said laser irradiation optical system is arranged pairwise so as to correspond to said two sheets of work.
